(19) United States
(12) Patent Application Publication
(10) Pub. No.: US 2006/0101526 A1
(43) Pub. Date: May 11, 2006

(54) Method, system and terminal for receiving content with authorized access

(76) Inventor: Jean-Claude Sachot, Betton (FR)

Correspondence Address: THOMSON LICENSING INC., PATENT OPERATIONS, PO BOX 5312, PRINCETON, NJ, 08543-5312, US

(21) Appl. No.: 10/516,784

(22) PCT Filed: Jun. 5, 2003
(86) PCT No.: PCT/EP03/06036

§ 371 Date: Aug. 9, 2005

(30) Foreign Application Priority Data
Jun. 5, 2002 (EP) 02291388.3
Jul. 24, 2002 (FR) 02/09362

(51) Int. Cl. H04N 7/16

(52) U.S. Cl. 726/29

(57) ABSTRACT

The invention relates to a conditional access content reception system comprising at least two terminals for accessing the content: a main terminal and at least one secondary terminal, each terminal comprising means for checking this terminal's authorization to access the content. It also comprises means for exchanging information between the main terminal and each secondary terminal, for the purpose of implementing and verifying the pairing between the secondary terminal and the main terminal, a condition which is necessary for the secondary terminal to access the content. The invention also relates to a method for receiving a conditional access content carried out in a system of this type and to a terminal for accessing this content

The present invention relates to a conditional access content reception system comprising at least two access terminals: one terminal referred to as “main” and at least one terminal referred to as “secondary”.

The invention also relates to a method for receiving a conditional access content carried out in such a system and to a terminal for accessing to this content.

The prior art has already disclosed conditional access content reception systems, notably for receiving pay-TV programs, which are based on the use of an access terminal such as a decoder which allows only authorized users to access the content. By way of example, the decoder comprises a smart card on which the user's access rights are recorded.

However, some users want to be able to access this content simultaneously at multiple locations in their home, which requires the use of as many reception terminals. For all that, the user is generally provided with these additional terminals by the content provider at a very advantageous cost, allowing access to the same content totally independently. In the prior art, to obtain protection from fraudulent use of the additional access terminals, which could be entrusted to third parties who have not obtained the rights, the content provider incorporates a telephone modem into each access terminal. He is therefore able to remotely control telephone calls from these access terminals to a server on a regular basis. Hence, analyzing the telephone number of the access terminals makes it possible to verify that this telephone number actually corresponds to that of the user who has obtained the rights and that the access terminals are geographically located at the premises of this user alone.

The major drawback of this method of checking is the need for the provider to have a private infrastructure for the purpose of regularly requesting calls from the access terminals, receiving and processing these calls. Added to this is the cost of the telephone modems which need to be installed on each access terminal, and the cost of the regular telephone calls.

Furthermore, the user must leave all of his access terminals permanently connected to the telephone network, which gives the impression of spying or of uncontrolled use of the telephone line, which is often accepted with resistance. The invention aims to overcome these drawbacks by eliminating all need for regular checking on the part of the content provider, while guaranteeing non-fraudulent use of the system.

To this end, the invention relates to a conditional access content reception system comprising at least two terminals for accessing the content: a main terminal and at least one secondary terminal, each terminal comprising means for checking this terminal's authorization to access the content, characterized in that each of the terminals also comprises pairing and pairing-verification means and in that the system comprises means for exchanging information between the main terminal and each secondary terminal for the purpose of implementing the pairing and the verification of the pairing between said secondary terminal and the main terminal.

Hence, a content reception system based on the invention allows the provider to be certain that the access terminals in the possession of a user who has obtained the rights are being used by that user only, without the need to make regular checks. In fact, a secondary terminal cannot work unless it is paired and able to communicate with a predetermined main terminal with which it was paired initially. The means for exchanging information between the main terminal and the secondary terminal (or terminals) thus allow this communication to be used to verify that the secondary terminal(s) is/are present in a predetermined area, this area guaranteeing the geographical proximity of the access terminals.

A system based on the invention may also comprise one or more of the following features:
the pairing and pairing-verification means of each secondary terminal prevent said secondary terminal from accessing the content if the verification of the pairing with the main terminal is negative;
the information-exchange means comprise a local area network to which the access terminals are connected;
the local area network is a wired or wireless private local area network;
the local area network is chosen from one of the elements from the group comprising a local area electrical network in the home of a user authorized to receive the content, a local area cable network in the home for the purpose of transmitting audiovisual information, a local area telephone network in the home and a wireless local area network in the home;
the local area network is merged with a shared network for distributing the content.

The invention also relates to a terminal for accessing to a conditional access content, referred to as “secondary terminal”, characterized in that it comprises means for pairing with a main access terminal, for the purpose of authorizing said secondary access terminal to access the content only if it is connected and able to exchange information with said main terminal.

A secondary access terminal based on the invention may also comprise one or more of the following features:
it comprises means for verifying its pairing with said main terminal with which it was paired initially;
the means for pairing and verifying the pairing with a main terminal comprise a peripheral module suitable for connection to said access terminal.

The invention also relates to a terminal for accessing to a conditional access content, referred to as “main terminal”, characterized in that it comprises means for pairing with at least one secondary access terminal through exchange of information with said secondary terminal.

According to one special feature of this terminal, the information exchanged is a unique identifier of said main terminal.

According to another feature of this terminal, the means for pairing with a secondary terminal comprise a peripheral module suitable for connection to said access terminal.

Finally, the invention also relates to a method for receiving conditional content carried out in the aforementioned system, characterized in that it comprises a step of testing the connection between the secondary terminal and the main terminal, the outcome of which is that the secondary terminal is authorized to process the content only if said connection has been set up.

The present invention will be better understood with the aid of the description which follows, which is given merely by way of example and with reference to the appended drawings, in which:

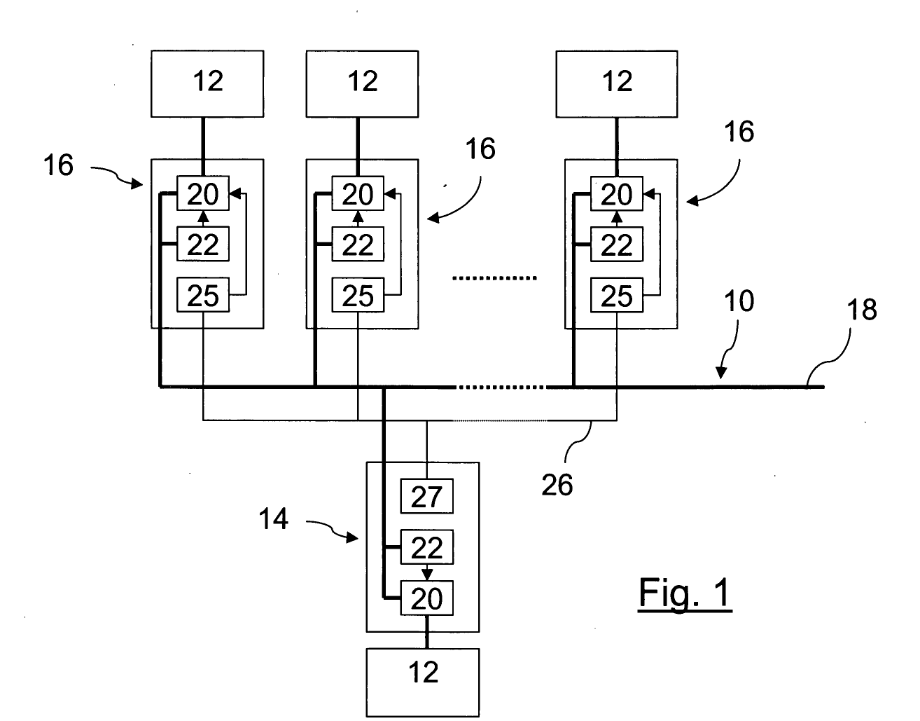

FIG. 1 shows a diagram of a conditional access content reception system based on the invention;

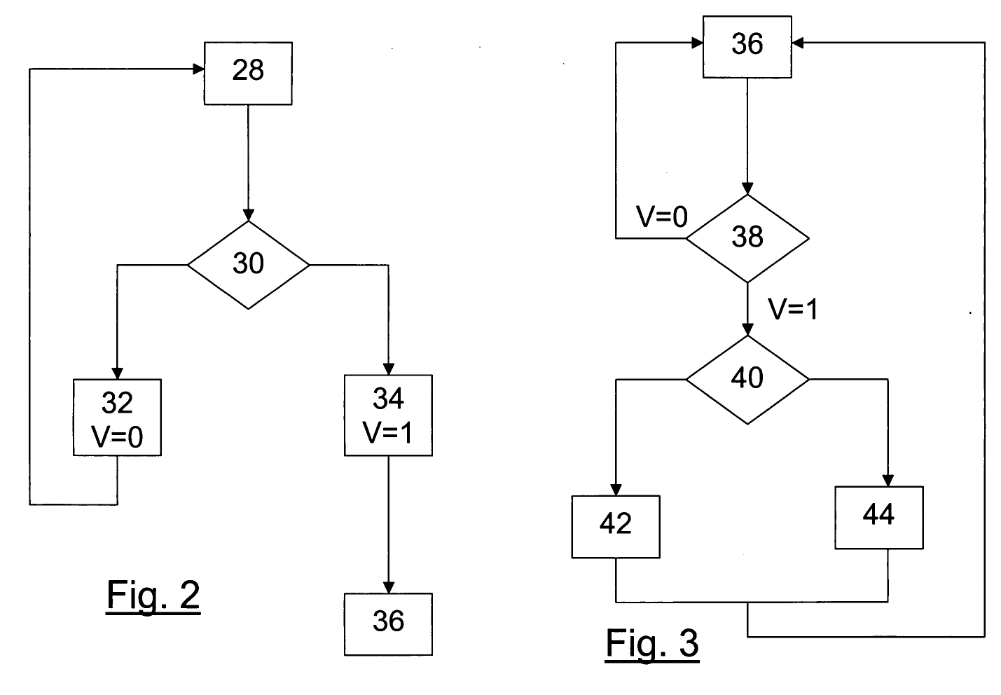

FIG. 2 shows the flowchart for a method for pairing a secondary terminal with a main terminal in accordance with the principle of the invention, carried out by the system of FIG. 1; and

FIG. 3 shows the flowchart for a method for verifying the connection between a secondary terminal and a predetermined main terminal, carried out by the system of FIG. 1.

The system shown in FIG. 1 is designed to receive a pay-to-access content 10. By way of example, this content 10 comprises audiovisual information intended to be shown on various television receivers 12 located in different rooms of a home.

As it is necessary to pay to access the content 10, viewing it requires interconnection of the access terminals 14, 16, such as the decoders, between each television 12 and a shared network 18 for distributing the content 10. One of these access terminals will be called the main terminal 14.

By way of example, the shared network 18 is the home's local area cable network for audiovisual transmission, or else is the domestic connection network with one or more individual satellite antennas.

The main terminal 14 comprises a unit 20 for processing the content. This unit 20 processes the content 10 in a manner which is known per se so as to allow it to be viewed on the television 12.

The main terminal 14 likewise comprises a module 22 for checking the authorization to access the content 10. This checking module 22 compares the user's access rights, which are stored on a smart card inserted into the terminal, for example, with information from the content 10 in order to determine whether the user can access the content. If appropriate, it then sends the processing unit 20 the authorization to process this content 10.

The other access terminals 16 are called secondary terminals. These terminals 16 likewise each comprise a content processing unit 20 which is identical to that of the main terminal 14 and also a module 22 for checking the authorization to access the content 10, which resembles that which the main terminal 14 contains. However, they also comprise pairing and pairing-verification modules 25.

It will be noted that the main terminal 14 also comprises a module 27 for pairing with one or more secondary terminals and for verifying the pairing.

A local area network 26 links each secondary terminal 16 to the main terminal 14 so as to allow the exchange of information which regularly ensures that the secondary terminals 16, for which the additional cost to the user is marginal, are actually being used within the home.

The local area network 26 is a network which belongs to the home, such as the home's local area electrical network. The frequency range in which the terminals operate is in this case chosen so that the communication does not spread beyond the user's meter. It may also be the home's local area telephone network or a wired or wireless data communication network in the home. More generally, it is any type of wired or wireless private local area network. The local area network 26 may likewise be merged with the shared network 18 in order to reduce the infrastructure and/or the cost of the system.

The method for pairing a secondary terminal 16 with the main terminal 14 and for checking the access to the content 10 by a secondary terminal 16, carried out by the pairing and pairing-verification modules 25 in the secondary terminal 16 and 27 in the main terminal 14, will now be described in conjunction with the flowcharts in FIGS. 2 and 3.

A description will first of all be given, in conjunction with FIG. 2, of the pairing method between a secondary terminal 16 and the main terminal 14. This method is carried out each time that a new secondary terminal is installed at the user's premises.

The method comprises a first initialization step 28 consisting of a trigger event, such as the first time that the secondary terminal 16 is started up, a periodic clock signal, or even the installation of the access terminal 16 on the shared network 18.

Following this trigger event 28, a test 30 for information exchange by the secondary terminal 16 with the main terminal 14 is activated. The secondary terminal 16 sends, by way of example, a request to the main terminal 14 for the latter to indicate a unique identifier which it has been allocated.

If the terminal 14 does not respond, then the secondary terminal 16 does not have a pairing, and a step 32 ensues in which the pairing and pairing-check module 25 declares an unauthorized state, defined by a variable V, which has been stored by this module 25 and has the value 0 by default. Following step 32, the pairing method returns to the initialization step 28.

If the terminal 14 gives a positive response, that is to say, in the embodiment above, if the terminal 14 sends its unique identifier to the terminal 16 which sent the request, then the secondary terminal stores the received identifier in its module 25 and it enters a state paired with the main terminal 14. There then follows a step 34 in which the pairing and pairing-check module 25 declares an authorized state defined by the variable V (which has been stored by this module 25), to which the value 1 is given. It will be noted that in the main terminal 14 it is the pairing and pairing-check module 27 which has the task of responding to any requests from the secondary terminal(s) so as to indicate the main terminal's identifier to them. Following step 34, the method is transferred to the first step of the checking method described in FIG. 3.

A description will now be given of the method for checking the access by the secondary terminal 16 to the content 10 in conjunction with FIG. 3. This method involves verifying the pairing between the secondary access terminal 16 and the main terminal 14 and not authorizing access to the content unless verification is positive. This method is carried out firstly by the pairing check module 25 in the secondary terminal 16 and secondly by the corresponding module 27 in the main access terminal 14.

This method allows regular verification that a secondary terminal 16 is being used permanently within the limits of the local area network 26 and is not being used wrongfully outside of the user's home.

It comprises a first initialization step 36 consisting of a trigger event, such as the secondary terminal 16 being started up, a periodic clock signal, the end of step 34 of the method in FIG. 2 or even the installation of the access terminal on the shared network 18.

Following this trigger event 36, a test 38 is carried out on the variable V held in the pairing verification module 25 in the terminal 16.

If the variable V is 0, which means that the secondary terminal 16 is not paired with the main terminal 14, the checking method is transferred to the initialization step 36 and it is not possible for the content 10 to be processed by the processing unit 20 in the secondary terminal 16. In practice, that implies that the television 12 connected to the secondary terminal 16 will not be able to display the received content 10 to the user (for example, if this content is sent in an encrypted or scrambled form, the signal sent to the television 12 will not be decrypted or unscrambled).

Alternatively, when the variable V is 0, it is also possible to envisage the user's rights which are stored in the secondary terminal (generally on a smart card inserted into the terminal 16) being removed immediately or after a delay. In this case, before the rights are actually removed, provision will be made for an explicit message to the user to be shown on the screen of the television 12 to warn him that his rights are being removed.

It will be noted that when the variable V is 0, it is necessary to repeat the initialization step 28 of the method described in FIG. 2 (that is to say by turning on the secondary terminal, for example) in order to be able to set this variable V to the value 1.

If the variable V is 1, a test 40 for connection of the secondary terminal 16 to the main terminal 14 is activated. This test involves an exchange of information between the secondary terminal 16 and the main terminal 14, such as an exchange of the identifier for the main terminal 14. In practice, the module 25 in the secondary terminal 16 uses the local area network 26 to ask for the identifier for the terminal 14. When the module 27 in the terminal 14 receives this request, it responds by sending its unique identifier. The module 25 in the secondary terminal 16 then compares the received identifier with that which was stored at the end of step 30 of the method in FIG. 2. If these two identifiers are identical, then the result of the test 40 is positive. In all other cases (the terminal 40 does not respond or the received identifier is not identical to that stored previously), the result of the test 40 is negative.

If the result of the test 40 is negative, a step 42 ensues in which the checking module 25 prevents the content 10 from being processed by the processing unit 20 in the secondary terminal 16. It will equally be possible in this case to show a message on the screen of the television 12 to warn the user that the pairing test has failed. Hence, if the secondary terminal 16 has been inadvertently disconnected from the local area network 26, the user will be able to connect it again.

If the result of the test 40 is positive, a step 44 ensues in which the checking module 25 authorizes processing of the content 10 by this processing unit 20.

Following steps 42 and 44, the checking method is transferred to the initialization step 36.

Among the advantages of the invention, it will be noted that once the local area network and the various access terminals have been installed on the user's premises by the provider, the conditional access content reception system based on the invention requires no intervention by the provider to verify non-fraudulent use of the conditional access content. This simplifies management and reduces operating costs for the content provider.

Another advantage of this reception system is that it does not require the use of telephone modems and hence that the user be on the telephone line on a regular basis.

The invention is not limited to the embodiment which has been described above.

In fact, the pairing and pairing-check modules respectively referenced 25 (in the secondary terminals) and 27 (in the main terminal), which are shown as forming an integral part of the access terminals in FIG. 1, may equally be implemented in the form of peripheral modules which are external to the terminals and are suitable for connection to these terminals.

1. A conditional access content reception system comprising at least two terminals accessing the content: a main terminal and at least one secondary terminal, each terminal comprising means for checking this terminal's authorization to access the content, wherein each of the terminals also comprises pairing and pairing-verification means and in that wherein the system comprises means for exchanging information between the main terminal and each secondary terminal for the purpose of implementing the pairing and the verification of the pairing between said secondary terminal and the main terminal.

2. The conditional access content reception system according to claim 1, wherein the pairing and pairing-verification means of each secondary terminal prevent said secondary terminal from accessing the content if the verification of the pairing with the main terminal is negative.

3. The conditional access content reception system according to claim 1, wherein the information-exchange means comprise a local area network to which the access terminals are connected.

4. Conditional access content reception system according to claim 3, wherein the local area network is a wired or wireless private local area network.

5. The conditional access content reception system according to claim 4, wherein the local area network is chosen from one of the elements from the group comprising a local area electrical network in the home of a user authorized to receive the content, a local area cable network in the home for the purpose of transmitting audiovisual information, a local area telephone network in the home and a wireless local area network in the home.

6. The conditional access content reception system according to claim 3, wherein the local area network is merged with a shared network for distributing the content.

7. A terminal for accessing to a conditional access content comprises comprising means for pairing with a main access terminal, for the purpose of authorizing said access terminal to access the content only if it is connected and able to exchange information with said main terminal.

8. The terminal for accessing to a conditional access content according to claim 7, further comprising means for verifying its pairing with said main terminal with which it was paired initially.

9. The terminal for accessing to a conditional access content according to claim 7, wherein the means for pairing and verifying the pairing with a main terminal comprise a peripheral module suitable for connection to said access terminal.

10. A terminal for accessing to a conditional access content comprising means for pairing with at least one secondary access terminal through exchange of information with said secondary terminal.

11. The terminal according to claim 10, wherein the information exchanged is a unique identifier for said terminal.

12. The terminal according to claim 10 wherein the means for pairing with a secondary terminal comprise a peripheral module suitable for connection to said access terminal.

13. A method for receiving a conditional access content carried out in a system as claimed in claim 1, wherein said method comprising a step of testing the connection between the secondary terminal and the main terminal, the outcome of which is that the secondary terminal is authorized to process the content only if said connection has been set up.
